(19) United States
(12) Patent Application Publication
(10) Pub. No.: US 2019/0138890 A1
(43) Pub. Date: May 9, 2019

(54) EXPANDABLE AND REAL-TIME RECOFIGURABLE HARDWARE FOR NEURAL NETWORKS AND LOGIC REASONING

(71) Applicants: Ping Liang, Newport Coast, CA (US); Biyonka Liang, Newport Coast, CA (US)

(72) Inventors: Ping Liang, Newport Coast, CA (US); Biyonka Liang, Newport Coast, CA (US)

(73) Assignee: Ping Liang, Newport Coast, CA (US)

(21) Appl. No.: 15/806,329

(22) Filed: Nov. 8, 2017

(51) Int. Cl. G06N 3/063; G06N 3/08; G06N 3/04

(52) U.S. Cl. CPC G06N 3/063; G06N 3/04; G06N 3/08

(57) ABSTRACT

This invention presents a scalable field-reconfigurable learning network and machine intelligence system that is reconfigured to match the architecture or processing flow of a selected deep learning neural network and well suited for combining neural network learning and logic reasoning. It partitions the N layers, clusters or stages of the selected learning network into multiple parts with inter-parts connections to a plural of field-reconfigurable processing modules. The inter-parts connections are configured into a field-reconfigurable processing and interconnection module. Multiple field-reconfigurable learning networks can be interconnected to produce a larger scale field-reconfigurable learning network, and can be connected to the Internet to provide a field-reconfigurable learning network cloud service.

### FIELD OF THE INVENTION

The present invention relates to field-reconfigurable neural networks and machine intelligence systems, and more specifically to a hardware system for neural networks that is expandable and field-reconfigurable to match the structure and processing flow of neural networks and logic reasoning.

### BACKGROUND

There are two phases in using a neural network for machine learning, training and inferencing. In the training phase, a computing engine needs to be able to process a large number training examples quickly, thus needs both fast processing and fast I/O. In the inferencing phase, a computing engine needs to receive input data and produce the inference results, in real-time in many applications. In both phases, the computing engine needs to be configured to implement the different neural network architectures that are best suited to a learning task, e.g., for human face recognition, speech recognition, handwriting recognition, playing a game or controlling a drone, etc., each may require a different neural network architecture, or structure and processing flow, e.g., number of layers, number of nodes at each layer, the interconnection among layers, types of processing performed at each layer, etc. Prior art computing engines for neural networks using GPU, FPGA or ASIC lack the high processing power, expandability, flexibility of interconnections of sub-engines and real-time configurability offered by this invention.

“A Cloud-Scale Acceleration Architecture” by A. M. Caulfield et al of Microsoft Corporation published at 49th Annual IEEE/ACM International Symposium on Microarchitecture in 2016 described an architecture that places a layer of FPGAs between the servers' Network Interface Cards (NICs) and the Ethernet network switches. It connects a single FPGA to a server CPU and connects many FPGAs through up to three layers of Ethernet switches. Its main advantages are in offering general purpose cloud computing services, allowing the FPGAs to transform network flows at line rate and accelerate local applications running on each server. It allows a large number of FPGAs to communicate, however, the connections between FPGAs need to go through one or more levels of Ethernet switches and requires a network operating system's coordination of the CPUs connected to each of the FPGAs. For a single CPU, the co-processing power is limited by the size and processing speed of the single FPGA attached to the CPU. The overall performance and FPGA to FPGA communication latency will heavily depend on the efficiency and the uncertainty of the multi-levels of Ethernet switches due to competition of other data traffic on the Ethernet switch network in a data center, and the network operating system's efficiency in managing, requesting, releasing and acquiring of the FPGA resources at a large number of other CPUs or servers. There is also prior art that attaches multiple FPGAs or GPUs to a server through a CPU or peripheral bus, e.g., the PCIe bus. There are no direct connections between the FPGAs or GPUs of one server with those of another server. A large neural network requiring a large number of FPGAs will need to involve multiple servers and their upper layer software overhead and latency.

This invention offers significant advantages in terms of reconfiguring and mapping configurable hardware to optimally match the structure and processing flow of a wide range of neural networks, in addition to overcoming the shortcomings in the prior art identified above.

### DESCRIPTION OF THE DRAWINGS

FIG. 1 shows the architecture of a field-reconfigurable learning network.

FIG. 2 shows a field-reconfigurable learning network reconfigured to implement a multi-layer deep learning neural network.

FIG. 3 shows a field-reconfigurable learning network reconfigured to implement simultaneously two multi-layer neural network.

FIG. 4 shows a field-reconfigurable learning network reconfigured to implement simultaneously two cooperating multi-layer neural network and a higher level learning network.

FIG. 5 shows four field-reconfigurable learning networks interconnected together to form a larger field-reconfigurable learning network.

### DETAILED DESCRIPTION OF THE PRESENT INVENTION

Reference may now be made to the drawings wherein like numerals refer to like parts throughout. Exemplary embodiments of the invention are provided to illustrate aspects of the invention and should not be construed as limiting the scope of the invention. When the exemplary embodiments are described with reference to block diagrams or flowcharts, each block represents both a method step or an apparatus element for performing the method step. Depending upon the implementation, the corresponding apparatus element may be configured in hardware, software, firmware or combinations thereof. In this invention, the term neural network or learning network, used interchangeably, means an information processing structure that can be characterized by a graph of layers or clusters of processing nodes and interconnections among the processing nodes, which include but are not limited to feedforward neural networks, deep learning network, convolutional neural networks, recurrent neural networks, self-organizing neural networks, long short term memory networks, gated recurrent unit networks, reinforcement learning networks, unsupervised learning networks, etc., or a combination of thereof. For example, a learning network may consist of one or more recurrent networks and one or more feedforward networks interconnected together. The term data, information, signal may be used interchangeably, each of which may mean a bit stream, signal pattern, waveform, binary data etc., which may be interpreted as weights, biases or timing parameters of a learning network, a command for a processing module, input to or output from a node, layer, cluster, processing stage etc. of a learning network.

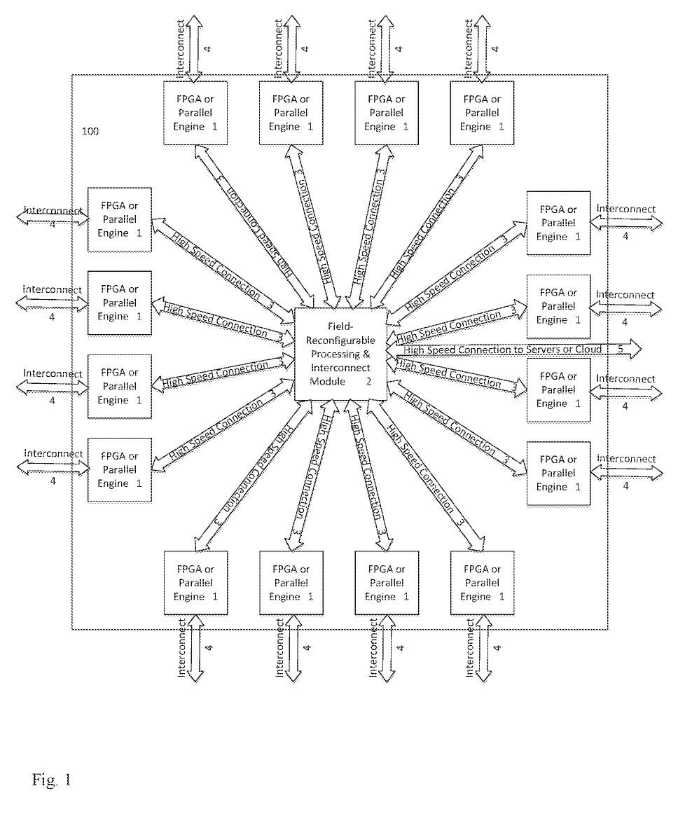

This invention includes embodiments of a method for implementing learning networks and the system or apparatus of a field-reconfigurable learning network 100, as shown in FIG. 1. The embodiments comprise partitioning the N layers, clusters or stages of a selected learning network into multiple parts with inter-parts connections based on a mapping of the architecture or processing flow of the selected learning network to a field-configurable learning network, configuring one or more field-reconfigurable very large scale integrated circuits on each of two or more processing modules 1 such that the partitioned multiple parts of the selected learning network are distributed over the two or more processing modules 1 with each of the processing modules implementing a subset of the multiple-parts partitions of the selected learning network, configuring a collection of field-reconfigurable connection circuits, e.g., in the FR-PIM 2, to connect one or more ingress high speed connections 3 and/or 5 to one or more egress high speed connections 3 or 5.

Hereafter, the term Field-Reconfigurable Processing and Interconnection Module 2 or FR-PIM 2 will be used to indicate either the collection of field-reconfigurable connection circuits alone or the collection of field-reconfigurable connection circuits together with some field-reconfigurable logic or computation circuits connected to the collection of field-reconfigurable connection circuits. For example, when the FR-PIM 2 is implemented using FPGA-type of circuits, it will include both field-reconfigurable connection circuits and field-reconfigurable logic or computation circuits. The connections established by the FR-PIM 2 include the inter-parts connections among the partitioned parts of the N layers, clusters or stages of the selected learning network distributed over the two or more processing modules for direct communication among the multiple parts through the such configured reconfigurable connection circuits, using a first set of one or more high speed connections 3 between the processing modules 1 and the FR-PIM 2 to send and receive signals between a source and a destination, using a second set of one or more high speed connections 5 for connecting the FR-PIM 2, or the two or more processing modules 1 via the FR-PIM 2, with one or more host servers to which the field-reconfigurable learning network 100 provides the function of a reconfigurable machine learning co-processor. A processing module can be either a source or a destination of a signal for a connection in the first set or second set of high speed connections with the FR-PIM 2.

Each processing module 1 contains a collection of field-reconfigurable circuits which can be field-reconfigured to perform a wide range of logic processing and computation and to connect a collection of inputs to a collection of outputs with or without logic or computations inserted in between. One method to achieve this is to include one or more field-reconfigurable very large scale integrated circuits, e.g., FPGA chips or field-reconfigurable parallel processing hardware, in a processing module. The collection of field-reconfigurable circuits make up the hardware of the field-reconfigurable learning network 100 which can be configured by software, prior to or at the time of use, to implement the selected learning network using. The FR-PIM 2 may also be implemented using a FPGA and can also include a memory module, e.g., block RAM or DRAM, that holds the parameters, settings, or data for some or all of the processing modules.

One embodiment configures the reconfigurable circuits in the FR-PIM 2 to interconnect each part of the N layers, clusters or stages that are partitioned into the two or more processing modules 1 such that the circuits of a first subset of the one or more processing modules configured to perform the computations of a kth layer, cluster or stage receive input information provided by the circuits of a second subset of the one or more processing modules configured to perform the computations of an mth layer, cluster or stage, and send output information to the circuits of a third subset of the one or more processing modules configured to perform the computations of an nth layer, cluster or stage which uses the received information as the input information, wherein 1≤k,m,n≤N, the circuits of the subset of the one or more processing modules configured for k=1 receive input data from an input data source, internal state or a memory, and the circuits of the subset of the one or more processing modules configured for k=N produce an output of the selected learning network, or send output information to the circuits of a subset of the one or more processing modules configured to perform the computations of a jth layer, cluster or stage, wherein 1≤j<N.

Each of the two or more processing modules 1 and their field-reconfigurable very large scale integrated circuits, e.g., FPGA chips, are reconfigured by software, at the time of or prior to use, to fit the architecture or processing flow of a selected neural network. The neural network may be a deep learning network or a recurrent network or other networks listed at the beginning of this section. The neural network is organized into N layers, clusters or stages, which are partitioned into a number of blocks with one or more blocks implemented in each of the two or more processing modules. Each processing module 1 implements a part of the selected learning network, and the processing modules 1 collectively implement the complete learning network. For some selected learning networks, the embodiment may partition the layers, clusters or stages such that multiple layers are implemented using the same or same subset of processing modules. On the other hand, neurons in the same layer or cluster may be duplicated in multiple processing modules, with each processing module performing the computation of the same layer or cluster of neurons but at different processing stages or states, e.g., in a pipeline configuration. These processing modules need to be connected, via the FR-PIM 2, to complete the function of the single layer or cluster. A recurrent network may be partitioned into multiple processing modules with each processing module implementing one or more layers or clusters of the recurrent network. The inter-layer or inter-cluster connections among the multiple processing modules will be provided by the FR-PIM 2.

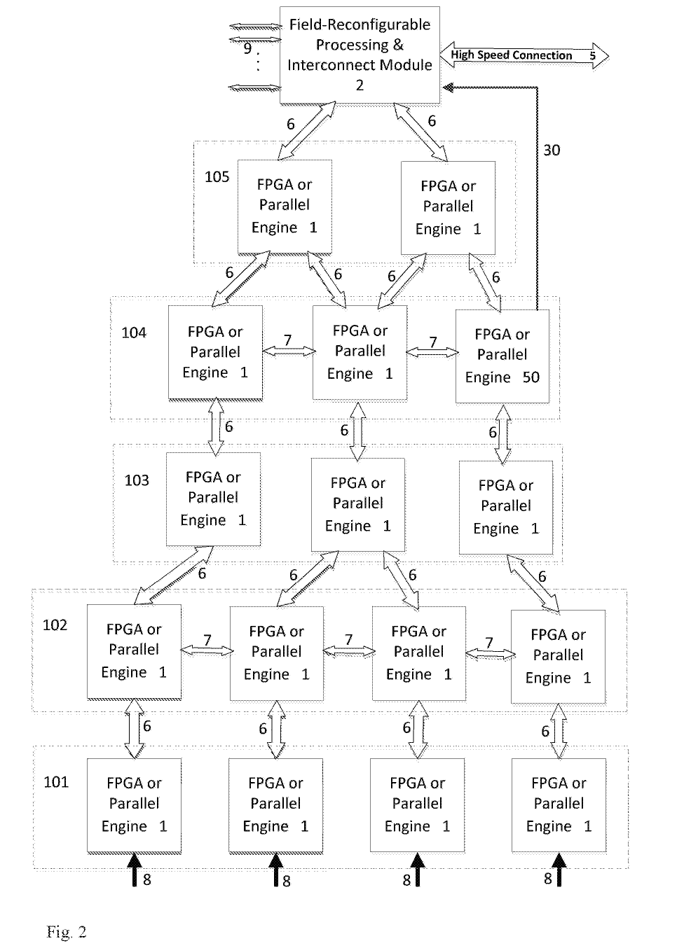

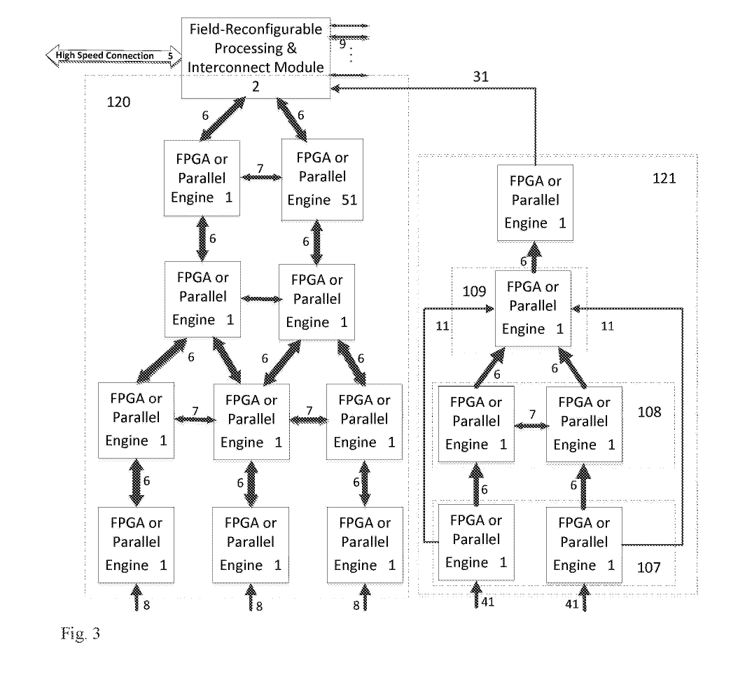

One example is to use a subset of processing modules for each of the N layers of a deep learning network as shown in FIG. 2, where 101 is the input layer and receives input signals through connections 8 which may be provided by the I/O ports or interconnect 4 or by the FR-PIM 2, and 102, 103, 104 and 105 are the hidden layers, and the FR-PIM 2 acts as the final output layer, in addition to configuring and interconnecting the different layers using inter-layer connections 6. The FR-PIM 2 configures its reconfigurable connection circuits to connect the first set of high speed connections 3 with the processing modules 1 at the different layers and the FR-PIM 2 to make up the inter-layer connections 6. In some networks, there are intra-layer connections 7 between the different processing modules, as shown in layers 102 and 104. The FR-PIM 2 creates the intra-layer connections 7 by connecting the first set of high speed connections 3 of the processing modules 1 in the same layer via reconfigurable connection circuits in FR-PIM 2. In some networks with sequentially ordered layers, e.g., feedforward deep learning neural networks, there are cross-layer connections 11 between non-adjacent layers, as shown in FIG. 3, where layer 107 connects to layer 109 via connections 11 which jumps over layer 108. The FR-PIM 2 creates the cross-layer connections 11 by connecting the first set of high speed connections 3 of the processing modules 1 in layer 107 with the first set of high speed connections 3 of the processing modules 1 in layer 109 via reconfigurable connection circuits in FR-PIM 2.

The FR-PIM 2 is reconfigured by software, at the time of or prior to use, to provide the interconnections among the parts of the N layers, clusters or stages of the selected learning network that are partitioned into the two or more processing modules, or subsets of the processing modules. A FR-PIM 2, implemented using an FPGA chip with a sufficient number of high speed I/O ports, uses its reconfigurable circuits to establish interconnections among the N layers, clusters or stages, or parts of, to connect one or more ingress high speed connections to one or more egress high speed connections through the established interconnections, to enable the source of the ingress high speed connection to send data directly to the destination of the egress high speed connection. This can be achieved as a direct circuit connection without the need of using the destination's address or ID. The reconfigurable circuits in the FR-PIM are configured to interconnect each part of the N layers, clusters or stages partitioned into the two or more processing modules such that the circuits of a first subset of the one or more processing modules, e.g., in layer 103, configured to perform the computations of a kth layer, cluster or stage, e.g., layer 3 in 103, receive input information provided by the circuits of a second subset of the one or more processing modules, e.g., in layer 102, configured to perform the computations of an mth layer, cluster or stage, e.g., layer 2 in 102, and send output information to the circuits of a third subset of the one or more processing modules, e.g., in layer 104, configured to perform the computations of an nth layer, cluster or stage, e g., layer 4 in 104, which uses the received information as the input information, wherein 1≤k,m,n≤N. The circuits of the subset of the one or more processing modules configured for k=1, e.g., in layer 101, receive input data via connections 8 from input data source, internal state or a memory, and the circuits of the subset of the one or more processing modules configured for k=N produce an output of the selected learning network, or send output information to the circuits of a subset of the one or more processing modules configured to perform the computations of another intermediate or hidden layer, cluster or stage.

A selected learning network may have recurrent connections wherein the kth layer receives input from and sends output to the same layer, i.e., n=m. In a learning network with sequentially ordered layers, clusters or stages from 1 to N, the field-reconfigurable learning network may be configured to have m<k<n or k≥n in one or more configurations.

In the implementation of some learning network, the FR-PIM is configured to insert reconfigurable computation circuit along the connection path from one or more ingress high speed connections to one or more egress high speed connections, wherein the said reconfigurable computation circuit processes the data as it passes through the connection path. The reconfigurable computation circuits in the FR-PIM can also be configured to function as an additional processing module of the field-reconfigurable learning network, being used to implement part or all of one or more layers, clusters or stages of a selected learning network.

In some learning networks, effective or efficient learning may require processing nodes that operate on concurrent or time-sensitive outputs, states, parameters, processing and/or configuration of multiple layers, clusters or stages. To implement such learning networks, one embodiment configures multiple processing modules to send data to the FR-PIM in parallel, and configures the reconfigurable computation circuits in the FR-PIM to receive the data and perform computation that requires time-sensitive inputs from one or more layers, clusters or stages that are distributed across the multiple processing modules. Another embodiment configures the reconfigurable computation circuits in the FR-PIM to perform computation on received data and/or data in memory and to transmit the resulting data from the computation in parallel to one or more layers, clusters or stages that are distributed across multiple processing modules. The multiple processing modules are configured accordingly to receive the data from the FR-PIM and perform processing in parallel. In yet another embodiment, the reconfigurable circuits in the FR-PIM are configured to receive signals from two or more processing modules in parallel and process the received signals to derive centralized control and/or coordination signals 9, and transmit the centralized control and/or coordination signals 9 to two or more processing modules. The two or more processing modules are configured to receive the centralized control and/or coordination signals 9 from the FR-PIM and modify their states, parameters, processing and/or configurations.

The FR-PIM may be equipped with a memory module which stores data shared by multiple processing modules. The reconfigurable circuits in the FR-PIM are configured to retrieve data from the memory and transmit the data to two or more processing modules which require the data for their function. The two or more processing modules are to be configured accordingly to receive the data from the FR-PIM, to use the data in the processing or modify their states, parameters, processing and/or configurations.

One embodiment implements multiple selected learning networks in a field-reconfigurable learning network, as shown in FIG. 3. It configuring a first set 120 of two or more processing modules to implement a first selected learning network and configures a second set 121 of two or more processing modules to implement a second selected learning network. In the example in FIG. 3, the FR-PIM 2 is configured to also perform the output layer, cluster or stage of the first selected learning network in 120, in addition of having its reconfigurable connection circuits of the FR-PIM configured to provide the inter-parts connections among the partitioned parts of each of the first and second selected networks. In this embodiment, each of the first and second selected learning networks is independent and the field-reconfigurable learning network carries out the learning or inference of both learning networks in parallel. In another embodiment, the reconfigurable connection circuits of the FR-PIM are configured to connect the first set of one or more processing modules with the second set of one or more processing modules. The first and the second selected learning networks are then configured to perform joint processing wherein the output, state, parameter, processing or configuration of one learning network depends on or are modified by the signals from the other network, thus making one or both of the selected learning networks dependent on the other selected learning network.

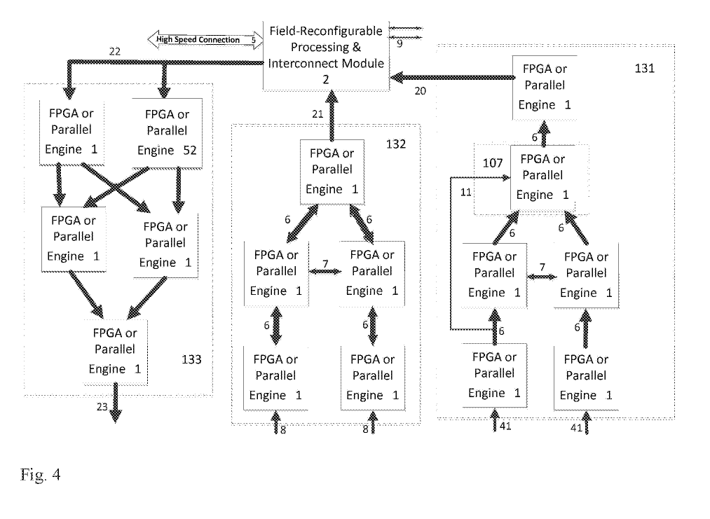

Another embodiment is cooperative learning networks and multi-level learning, in which the two or more processing modules are configured to implement two or more learning networks, e.g., a first set of one or more processing modules 131 implementing a first learning network and a second set of one or more processing modules 132 implementing a second learning network as shown in FIG. 4, wherein each of the selected learning networks performs a specialized function, e.g., one or more learning networks for visual object recognition, one or more learning networks for speech reignition or natural language understanding, one or more learning networks for contextual processing. Each of the learning networks provides its processing result as input to another higher level learning network implemented in a third set 133 of one or more processing modules. The FR-PIM is configured to connect the output signals 20 and 21 of the two or more learning networks to the input of a higher level learning network 133 which combines the results 20 and 21 from the two or more learning networks and performs a higher level learning and/or inference, e.g, fusing the results from the visual object recognition learning network, the speech recognition learning network and the contextual processing neural network to learn or infer the action or true intention of a person. In this embodiment, part or all of the higher level learning network may be implemented in the FR-PIM 2. When the FR-PIM is configured to implement all of the higher level learning network, the FR-PIM outputs the result of the higher level learning network. When the FR-PIM is configured to implement a part of the higher level learning network, the FR-PIM provides the output 22 of the first part of the one or more layers, clusters or stages of the higher level learning network as the input to the third set 133 of one or more processing modules configured to implement the remaining layers, clusters or stages of the higher level learning network. In FIG. 4, the output 23 of the third set of one or more processing modules provides the result of the higher level learning network. The embodiment shown in FIG. 4 is a configuration of a field-reconfigurable learning network implementing multiple cooperating learning networks providing inputs to a higher level learning network. In case a single field-reconfigurable learning network does not have sufficient processing modules to implement the multiple cooperating learning networks and the higher level learning network, additional processing modules are added or multiple field-reconfigurable learning networks are interconnected through the FR-PIM to implement some of the layers, clusters or stages of the cooperating learning networks and/or the higher level learning network. The reconfigurable computation circuits in FR-PIM can be configured to be one of the processing modules of the higher level learning network, performing computation of some of its layers, clusters or stages, while additional layers, clusters or stages of the higher level learning network are implemented using one or more additional processing modules in the same or another field-reconfigurable learning network.

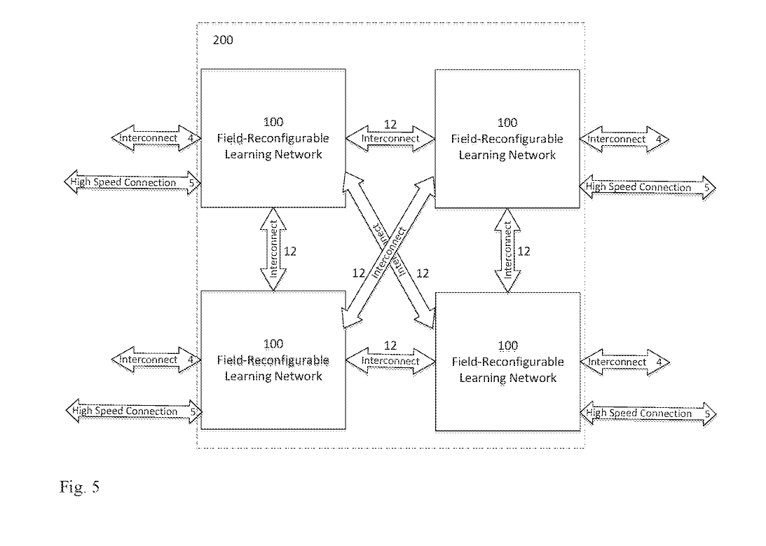

There is a need to get a large amount of data in and out of the field-reconfigurable learning network, for training a learning network with a large amount of examples in the training phase, and for running real-time data to get real-time results in the inference phase. In one embodiment, a processing module further comprises one or more high speed interconnects or I/O ports 4. These I/O ports 4 can be used to connect the field-reconfigurable learning network to an external system or to a computer network, e.g., a cloud data center network or the Internet, for entering input data into or providing output data from the learning network. In another embodiment, the I/O ports 4 can also be used to connect with the I/O ports 4 of one or more other field-reconfigurable learning networks 100 to produce a larger field-reconfigurable learning network 200, as shown in FIG. 5 where the interconnects 12 used connect the multiple field-reconfigurable learning networks are the I/O interconnects 4 shown in FIG. 1. This is important because there is a limit on how many processing modules can be connected through a FR-PIM, and a selected learning network may require more processing power and/or connections than the processing modules and FR-PIM of a single field-reconfigurable learning network can provide. The interconnected multiple field-reconfigurable learning networks 100 are configured to function as a larger field-reconfigurable learning network 200 by software at time of or prior to use. Furthermore, some or all of the multiple interconnected field-reconfigurable learning networks 100 can be connected, via the second set of high speed connections through one or more FR-PIM, with one or more interconnected host servers, and the multiple field-reconfigurable learning networks interconnected via their I/O ports collectively function as a co-processing system for the one or more interconnected host servers. Thus, the field-reconfigurable learning network of this invention is scalable by adding more processing modules and by interconnecting multiple field-reconfigurable learning networks to produce a larger scale field-reconfigurable learning network 200.

Another embodiment of scaling into a larger field-reconfigurable learning network is by connecting the FR-PIMs 2 of multiple field-reconfigurable learning networks 100 using a third set of one or more high speed connections 12, and configuring the multiple FR-PIMs and the processing modules of the such interconnected multiple field-reconfigurable learning networks to work as a single larger field-reconfigurable learning network 200, as shown in FIG. 5. Similarly, some or all of the interconnected multiple field-reconfigurable learning can be connected, via the second set of high speed connections through one or more FR-PIM 2, with one or more interconnected host servers, and the multiple field-reconfigurable learning networks 100 interconnected through their integrated FR-PIM collectively functions as a co-processing system for the one or more interconnected host servers. Similarly, a field-reconfigurable learning network of any scale in this invention can be connected to the Internet through one or more of the high speed I/O ports on the processing modules, the one or more FR-PIMs and/or the one or more interconnected host servers to provide a cloud service using the field-reconfigurable learning network.

Neural network learning is only one aspect of machine intelligence. Logic reasoning coupled with neural networks provide a more powerful general machine intelligence computing engine. GPU and CPU are less efficient in implementing logic than FPGA-type of circuits whose logic circuits can be reconfigurable to efficient compute sequential and combinatorial logic as the signals pass through the circuits. It is difficult for special purpose neural network ASIC or ASIC with fixed logic to implement logic reasoning other than those pre-designed into the fixed logic circuits. FPGA-type of circuits with reconfigurable logic are designed for and well suited for implementing a wide range of logic through configuration by software, and can implement logic reasoning more efficiently than GPU, CPU and ASIC and can complete logic reasoning faster than them. One embodiment is a field-reconfigurable machine intelligence method or system comprising two or more processing modules 1 which includes FPGA-type of circuits with reconfigurable logic, computation and connection circuits, a collection of field-reconfigurable connection circuits, e.g., those in the FR-PIM 2, a first set of one or more high speed connections 3 between the processing modules and the collection of field-reconfigurable connection circuits, e.g., in FR-PIM 2. The reconfigurable logic, computation and connection circuits in the two or more processing modules 1 are configured to implement one or more selected learning networks which are partitioned into multiple parts with each part implemented in a subset of the processing modules 1. The collection of field-reconfigurable connection circuits, e.g., in the FR-PIM 2, are reconfigured to interconnect the partitioned parts of the one or more selected learning networks. While some of the reconfigurable logic, computation and connection circuits in the processing modules 1 and/or FR-PIM 2 are configured to implement one or more selected learning networks, some of the reconfigurable logic, computation and connection circuits in the processing modules 1 and/or FR-PIM 2 are configured to perform logic reasoning and combine results from the one or more selected neural networks and logic reasoning to produce the result of the machine intelligence system.

The collection of the field-reconfigurable circuits of the system, in FR-PIM 2, are configured to establish connections of the signals of the implemented one or more selected learning networks and the signals of the implemented logic reasoning circuits. These connections can be from the output layer, cluster or stage of a selected learning network, or an intermediate layer, cluster or stage of a selected learning network to the input of the field-reconfigured logic reasoning circuit, or from the output of a field-reconfigured logic reasoning circuit to the output or an intermediate layer, cluster or stage of a selected learning network. They can also be for connecting the output layer, cluster or stage of a selected learning network, or an intermediate layer, cluster or stage of a selected learning network and the output of one or more field-reconfigured logic reasoning circuits to the input of one or more selected learning networks and/or the input of one or more one or more field-reconfigured logic reasoning circuits. These connections can all be established using the collection of field-reconfigurable connections circuits, e.g., in FR-PIM 2 and using the signals 9. The outcome is that that field-reconfigurable machine intelligence system combines the signals from the implemented one or more selected learning networks and the output from the one or more implemented logic reasoning circuits to produce one or more output of the system.

In FIG. 2, the reconfigurable logic, computation and connection circuits in the processing modules 50 are configured to perform logic reasoning using inputs from the selected learning network, obtained from one or more of the processing modules 1 or reconfigurable logic circuits connected to the collection of field-reconfigurable connection circuits, e.g., the FR-PIM 2, and provide the result from the logic reasoning to the FR-PIM 2 via connection 30. The reconfigurable logic, computation and connection circuits in FR-PIM 2 are configured to combine the result from the selected learning network and the logic reasoning result to produce the output of the machine intelligence system. Some of the reconfigurable logic circuits in FR-PIM 2 can be configured to perform logic reasoning using the results from the one or more selected learning networks implemented in the field-reconfigurable learning network to produce one or more outputs which can be provided as the result of the machine intelligence system and/or fed back to one or more processing modules 1. For example, in FIGS. 2, 3 and 4, connections 9 can accept signals from one or more processing modules 1 which represent intermediate results from the one or more selected learning networks, and provide output signals from logic reasoning to one or more processing modules 1 to affect or modify the processing of the one or more selected learning networks.

FIG. 3 can represent another implementation in which the processing modules in 121 are configured to perform logic reasoning on inputs 41, which can be from external sources, output or control signals 9 generated by the FR-PIM 2, and/or results from the one or more selected learning networks implemented in 120, and the result from logic reasoning in 121 is provided via connection 31 to the reconfigurable logic, computation and connection circuits in FR-PIM 2 which are configured to either combine the result from the one or more selected learning networks and the logic reasoning result 31 to produce the output of the machine intelligence system, or to connect the logic reasoning result 31 to another processing module which is configured to produce the output of the machine intelligence system. An example of a processing module 51 configured to perform logic reasoning alongside with a learning network 120 is also shown in FIG. 3.

FIG. 4 can represent another implementation in which the processing modules in 131 are configured to perform logic reasoning on inputs 41, which can be from external sources, output or control signals 9 generated by the FR-PIM 2, and/or results from the one or more selected learning networks implemented in 132 and/or 133, and the result from logic reasoning in 131 is provided via connection 20 to the reconfigurable logic, computation and connection circuits in FR-PIM 2 which are either configured to combine the result from the one or more selected learning networks and the logic reasoning result 20 to provide the input signals to another learning network in 133, or to connect the logic reasoning result 30 to the learning network in 133 which is configured to combine the result from logic reasoning by 131 and result from the learning network(s) in 132 to produce the output of the machine intelligence. An example of a processing module 52 configured to perform logic reasoning alongside with a higher level learning network 120 is shown in FIG. 4.

The field-reconfigurable machine intelligence system can be connected to one or more connected host servers, and/or to a computer network, e.g., a local area network or the Internet, to provide a web service or cloud service. Multiple field-reconfigurable machine intelligence systems can be connected together to produce a larger field-reconfigurable machine intelligence system, e.g., by connecting the processing modules of the multiple systems or connecting a central connection hub in each of the field-reconfigurable machine intelligence systems. Each of some of the multiple field-reconfigurable machine intelligence systems can be connected to a computer network to provide machine intelligence access or service of a larger field-reconfigurable machine intelligence system over the computer network, e.g., as a web service or cloud service.

Multiple field-reconfigurable machine intelligence systems 100 can be connected together to produce a larger field-reconfigurable machine intelligence system 200 as shown in FIG. 5. The interconnect 12 between the multiple field-reconfigurable machine intelligence systems 100 can be either the I/O ports or interconnect 4 or the high speed connections 5 or a combination of them.

Although the foregoing descriptions of the preferred embodiments of the present inventions have shown, described, or illustrated the fundamental novel features or principles of the inventions, it is understood that various omissions, substitutions, and changes in the form of the detail of the methods, elements or apparatuses as illustrated, as well as the uses thereof, may be made by those skilled in the art without departing from the spirit of the present inventions. Hence, the scope of the present inventions should not be limited to the foregoing descriptions. Rather, the principles of the inventions may be applied to a wide range of methods, systems, and apparatuses, to achieve the advantages described herein and to achieve other advantages or to satisfy other objectives as well.

1. A method for implementing learning networks using multiple Field-Programmable Gate Arrays (FPGAs) comprising
partitioning the N layers, clusters or stages of a selected learning network into multiple parts with inter-parts connections based on a mapping of the architecture or processing flow of the selected learning network into two or more processing modules,
configuring the field-reconfigurable circuits in two or more FPGAs to implement the two or more processing modules such that the partitioned multiple parts of the selected learning network are distributed over the two or more FPGAs;
configuring a collection of field-reconfigurable connection circuits in one or more of the FPGAs to establish direct circuit connection for the inter-parts connections among the partitioned parts of the N layers, clusters or stages of the selected learning network distributed over the two or more FPGAs for direct communication among the multiple parts through the such configured reconfigurable connection circuits;
using a set of one or more connections to connect one or more of the multiple FPGAs with one or more host servers and/or a computer network to which the field-reconfigurable learning, network provides the function of a reconfigurable machine learning processor; and
configuring the field-reconfigurable connection circuits in the two or more FPGAs to interconnect the parts of the N layers, clusters or stages that are implemented in each FPGA such that, in combination with the inter-parts direct circuit connections between the two or more FPGAs, the circuits of a first subset of the one or more processing modules, configured to perform the computations of a kth layer, cluster or stage, receive input information provided by the circuits of a second subset of the one or more processing modules configured to perform the computations of an mth layer, cluster or stage, and send output information to the circuits of a third subset of the one or more processing modules configured to perform the computations of an nth layer, cluster or stage which uses the received information as its input information, wherein 1≤k,m,n≤N, the circuits of the subset of the one or more processing modules configured for k=1 receive input data from an input data source, internal state or a memory, and the circuits of the subset of the one or more processing modules configured for k=N produce an output of the selected learning network, or send output information to the circuits of a subset of the one or more processing modules configured to perform the computations of a jth layer, cluster or stage, wherein 1≤j<N.

2. The method according to claim 1 further comprising inserting field-reconfigurable logic or computation circuit along the connection path from an ingress connection to an egress connection, wherein the said field-reconfigurable logic or computation circuit processes the data as it passes through the connection path.

3. The method according to claim 1 further comprising configuring multiple processing modules to send data to the collection of field-reconfigurable connection circuits in parallel, and configuring reconfigurable logic or computation circuits connected to the collection of field-reconfigurable connection circuits to process the received data using concurrent or time-sensitive inputs from one or more layers, clusters or stages that are distributed across the multiple processing modules.

4. The method according to claim 1 further comprising configuring reconfigurable logic or computation circuits to perform processing on the data received by the collection of field-reconfigurable connection circuits to perform processing on received data and/or data in memory and transmit the resulting signal from the processing to multiple processing modules in parallel; and configuring the multiple processing modules to receive the signal from the collection of field-reconfigurable connection circuits and perform processing in parallel.

5. The method according to claim 1 further comprising configuring the collection of field-reconfigurable connection circuits to receive signals from two or more processing modules in parallel, processing the received signals to derive centralized control and/or coordination signals, and transmit the centralized control and/or coordination signals to two or more processing modules; and configuring the processing modules to receive the centralized control and/or coordination signals from the collection of field-reconfigurable connection circuits and modify their state, parameter, processing and/or configuration.

6. The method according to claim 1 further comprising storing data shared by multiple processing modules in a memory attached to the collection of field-reconfigurable connection circuits; configuring the collection of field-reconfigurable connection circuits to retrieve data from the memory and transmit the data to two or more processing modules; and configuring the processing modules to receive the data from the collection of field-reconfigurable connection circuits, use the data in the processing or to modify their state, parameter, processing and/or configuration.

7. The method according to claim 1 further comprising using one or more I/O ports of one or more processing modules to connect the field-reconfigurable learning network to an external system or to a computer network.

8. The method according to claim 1 further comprising interconnecting the collections of field-reconfigurable connection circuits of multiple field-reconfigurable learning networks using a third set of one or more connections, and configuring the multiple collections of field-reconfigurable connection circuits and the processing modules of the such interconnected multiple field-reconfigurable learning networks to function as a single larger field-reconfigurable learning network.

9. The method according to claim 1 further comprising configuring a first set of two or more processing modules to implement a first selected learning network; configuring a second set of two or more processing modules to implement a second selected learning network; and configuring the collection of field-reconfigurable connection circuits to provide the inter-parts connections among the partitioned parts of the first and second selected network.

10. The method according to claim 9 further comprising configuring the collection of field-reconfigurable connection circuits to connect one or more processing modules in the first set with one or more processing modules in the second set; and configuring the first and second sets so that the two selected learning networks perform joint processing wherein the output, state, parameter, processing or configuration of one learning network depends on or is modified by the other learning network.

11. The method according to claim 1 further comprising configuring the two or more processing modules to implement two or more selected learning networks and a higher level learning network, wherein each of the selected learning networks performs a specialized function and provides its processing result as input to the higher level learning network; configuring the collection of field-reconfigurable connection circuits to connect the output signals of the two or more selected learning networks to the input of the higher level learning network which combines the results from the two or more selected learning networks and performs a higher level learning and/or inference.

12. A method of implementing a field-reconfigurable machine intelligence system comprising
partitioning one or more selected learning networks into multiple parts with inter-parts connections based on a mapping of the architecture or processing flow of the selected learning networks into two or more processing modules;
configuring the field-reconfigurable circuits in two or more FPGAs to implement the two or more processing modules such that the partitioned multiple parts of the one or more selected learning, networks are distributed over the two or more FPGAs;
configuring some of the reconfigurable circuits in the same two or more FPGAs into one or more logic reasoning circuits to perform logic reasoning;
configuring a collection of field-reconfigurable connection circuits in one or more of the FPGAs to establish direct circuit connection for the inter-parts connections among the partitioned parts of the one or more selected learning network distributed over the two or more FPGAs for direct communication among the multiple parts through the such configured field-reconfigurable connection circuits; and
configuring a collection of field-reconfigurable connection circuits in the same two or more FPGAs to establish connections of the signals of the one or more selected learning networks and the signals of the one or more logic reasoning circuits for the purpose of combining the signals to produce an output of the field-reconfigurable machine intelligence system.

13. The method according to claim 12 wherein combining the signals to produce an output comprises using one or more signals from the one or more selected learning networks as inputs to the one or more logic reasoning circuits.

14. The method according to claim 12 wherein combining the signals to produce an output comprises using one or more signals from the one or more logic reasoning circuits to affect or modify the processing of the one or more selected learning networks.

15. The method according to claim 12 further comprising connecting the output layer, cluster or stage of a selected learning network, or an intermediate layer, cluster or stage of a selected learning network and the output of one or more logic reasoning circuits to the input of one or more selected learning networks and/or to the input of one or more logic reasoning circuits.

16. The method according to claim 12 further comprising connecting the field-reconfigurable machine intelligence system to one or more connected host servers and/or to a computer network.

17. The method according to claim 12 further comprising connecting multiple field-reconfigurable machine intelligence systems to produce a larger field-reconfigurable machine intelligence system.

18. A field-reconfigurable machine intelligence system comprising
two or more processing modules each comprising one or more Field Programmable Gate Array (FPGA) which is reconfigured by software to implement a part of a selected learning network with N layers, clusters or stages, wherein the selected learning network is partitioned into multiple parts with inter-parts connections and the multiple parts are distributed over the two or more processing modules with a single processing module implementing a subset of the multiple-parts partition of the selected learning network;
a collection of field-reconfigurable connection circuits in one or more of the FPGAs that are reconfigured to establish direct circuit connection for the inter-parts connections among the partitioned parts of the N layers, clusters or stages of the selected learning network that are distributed over the two or more processing modules for direct communication among the multiple parts through the such configured reconfigurable connection circuits;
one or more connections to connect the FPGAs with one or more host servers and/or a computer network to which the field-reconfigurable machine intelligence system provides the function of a field-reconfigurable machine intelligence processor;
a collection of field-reconfigurable connection circuits in each of the FPGAs that are configured to interconnect each part of the N layers, clusters or stages that are implemented in each FPGA such that, in combination with the inter-parts direct circuit connections between the two or more FPGAs, the circuits of a first subset of the one or more processing modules, configured to perform the computations of a kth layer, cluster or stage, receive input information provided by the circuits of a second subset of the one or more processing modules configured to perform the computations of an mth layer, cluster or stage, and send output information to the circuits of a third subset of the one or more processing modules configured to perform the computations of an nth layer, cluster or stage which uses the received information as its input information, wherein 1≤k,m,n≤N, the circuits of the subset of the one or more processing modules configured for k=1 receive input data from an input data source, internal state or a memory, and the circuits of the subset of the one or more processing modules configured for k=N produce an output of the selected learning network, or send output information to the circuits of a subset of the one or more processing modules configured to perform the computations of a jth layer, cluster or stage, wherein 1≤j<N.

19. The field-reconfigurable machine intelligence system according to claim 18 further comprising one or more processing modules each comprising FPGA-type of field-reconfigurable circuits that are configured into one or more logic reasoning circuits to perform logic reasoning; and one or more processing modules that combines signals from the selected learning network and signals from the one or more logic reasoning circuits to produce an output, wherein the collection of field-reconfigurable connection circuits are configured to provide the connections of the signals of the selected learning network and the one or more logic reasoning circuits needed for the combination.

20. The field-reconfigurable machine intelligence system according to claim 18 further comprising field-reconfigurable logic or computation circuits that are inserted along the connection path from an ingress connection to an egress connection, wherein the said field-reconfigurable logic or computation circuits process the data as it passes through the connection path.

21. The field-reconfigurable machine intelligence system according to claim 18 further comprising parallel data paths between multiple processing modules and the collection of field-reconfigurable connection circuits, wherein the collection of field-reconfigurable connection circuits are configured to receive data from at least two processing modules concurrently and send the received data to at least one processing module which performs computation that requires concurrent or time-sensitive inputs from the at least two processing modules.

22. The field-reconfigurable machine intelligence system according to claim 18 further comprising a memory module connected to the collection of field-reconfigurable connection circuits and through which to two or more processing modules, wherein the memory module stores data shared by multiple processing, modules and the processing modules retrieve data from the memory module and use the data in the processing or to modify their state, parameter, processing and/or configuration.

23. The field-reconfigurable machine intelligence system according to claim 18 further comprising parallel control paths between multiple processing, modules and the collection of field-reconfigurable connection circuits, wherein the collection of field-reconfigurable connection circuits are configured to transmit a centralized control and/or coordination signal to at least two processing modules concurrently.

24. The field-reconfigurable machine intelligence system according to claim 18 wherein some or all of the processing modules further comprise one or more I/O ports for connecting to an external system or to a computing network.

25. The field-reconfigurable machine intelligence system according to claim 18 further comprising another set of one or more connections for connecting with one or more other field-reconfigurable machine intelligence systems, wherein the such interconnected multiple field-reconfigurable machine intelligence systems are configured to function as a larger field-reconfigurable machine intelligence system and as a co-processing system for one or more interconnected host servers.

26. The field-reconfigurable machine intelligence system according to claim 18, which comprises:
one or more first collections of field-reconfigurable circuits, each of which is field-reconfigured to perform computations of a first neural network or a first partitioned part of a first neural network;
one or more second collections of field-reconfigurable circuits, each of which is field-reconfigured to perform computations of a second neural network or a second partitioned part of the first neural network;
one or more third collections of field reconfigurable circuits, each of which is field-reconfigured as sequential and/or combinatorial logic reasoning circuit; and
a fourth collection of field-reconfigurable connection circuits that are field-reconfigured to establish direct circuit connections between the neural network implemented in the one or more first collections of field-reconfigurable circuits and the neural network implemented in the one or more second collections of field-reconfigurable circuits; to connect the output of one or more neurons implemented in the one or more first collections of field reconfigurable circuits to one or more input of a logic reasoning circuit implemented in the one or more third collections of field reconfigurable circuits; and to connect the output of the logic reasoning circuit to the input of one or more neurons implemented in the one or more second collections of field reconfigurable circuits, to connect the output of the logic reasoning circuit to the input of another logic reasoning circuit implemented in the one or more third collections of field reconfigurable circuits, and/or to modify the states, parameters, processing and/or configurations of, the neural network implemented in the one or more second collections of field-reconfigurable circuits,
wherein the neural network implemented in the one or more second collections of field-reconfigurable circuits and/or one or more of the logic reasoning circuits combine the signals from the neural networks implemented in the one or more first collections of field-reconfigurable circuits and the one or more second collections of field-reconfigurable circuits and the logic reasoning circuits to produce an output of the field-reconfigurable system.
